(19) United States
(12) Patent Application Publication
(10) Pub. No.: US 2009/0130642 A1
(43) Pub. Date: May 21, 2009

(54) Educational Simulator for Transthoracic Echocardiography

(75) Inventors: Fukuji Tada, Mitaka-city (JP); Hiroshi Nagai, Mitaka-city (JP); Yoshiyuki Fukushima, Mitaka-city (JP)

Correspondence Address: POSZ LAW GROUP, PLC, 12040 SOUTH LAKES DRIVE, SUITE 101, RESTON, VA, 20191, US

(73) Assignee: HRS CONSULTANT SERVICE, INC., Mitaka-city (JP)

(21) Appl. No.: 11/992,655

(22) PCT Filed: Dec. 18, 2006
(86) PCT No.: PCT/JP2006/325161

§ 371 Date: Mar. 27, 2008

(30) Foreign Application Priority Data
Dec. 26, 2005 (JP) 2005-371816

(51) Int. Cl. G09B 23/28

(52) U.S. Cl. 434/262

(57) ABSTRACT

The present invention relates to a simulation device for ultrasonic diagnosis targeting a heart and its object is to provide an educational simulator for transthoracic echocardiography which can run simulations in a feeling like actual ultrasonic diagnosis. The educational simulator for transthoracic echocardiography is composed of a chest phantom with position sensors embedded at prescribed positions beneath the chest surface, a dummy probe in which a magnet is embedded and which is provided with an inclination sensor placed in the acral part, a memory section which stores three-dimensional image data of echocardiography, a CPU which calculates the position, inclination and pressing force of the dummy probe on the basis of information from each said sensor and clips two-dimensional image data from the three-dimensional image data on the basis of the calculation, and a display section which shows the clipped two-dimensional data.

### CROSS-REFERENCE TO RELATED APPLICATION

This application is a U.S. national stage application of PCT/JP2006/325161 filed on Dec. 18, 2006, which is based on Japanese Patent Application No. 2005-371816 filed on Dec. 26, 2005, the disclosures of which are incorporated herein by reference.

### FIELD OF THE INVENTION

The present invention relates to an educational simulator for learning transthoracic echocardiography.

### BACKGROUND OF THE INVENTION

Generally, it is very important to obtain high-quality echo records in ultrasonic diagnosis. It is said that a lot of training and experience is required until a physician or an ultrasound technician can perform an examination and exercise exact ultrasonic diagnosis by manipulating an ultrasonic diagnostic device. Particularly, the scanning of an ultrasonic probe requires sophisticated skills and the operator must take images while delicately controlling the position, angle, contact pressure and so on of the ultrasonic probe when it is applied to a subject.

In echocardiography, too capturing records of high image quality is of great importance. The heart is a quickly beating organ, and it is surrounded with ribs and lungs so that echocardiographic records can be obtained only at a limited prescribed place away from the ribs and lungs which reflect ultrasonic waves.

To record the action of the heart at the prescribed place, orientation in consciousness of the three-dimensional entire picture is needed in scanning ultrasonic images. This requires more technology acquisition of echocardiography than in recording the action of other organs.

Meanwhile, a sophisticated ultrasonic diagnostic apparatus is expensive, and it is difficult to find a subject having a prescribed visceral disorder. An educational simulation device, therefore, is awaited in medical education circles.

The conventional educational simulator for ultrasonic diagnosis shows only static images and therefore is far from being suitable for the acquisition of diagnostic skills by dynamic images which is the salient feature of the ultrasonic diagnostic device. It has been limited to use in learning the positioning of the probe for examining each organ.

The detection of the position of the ultrasonic probe is an essential technology in the educational simulator regarding ultrasonic diagnosis. A spatial position sensor is used for the technology of detecting the position of the ultrasonic probe. There is a magnetic spatial sensor utilizing magnetism, for example, as the spatial position sensor which has been used heretofore. This magnetic spatial sensor uses a principle that electromotive force is generated in a coil owing to changes in magnetic flux. However, it is expensive, and it has a demerit that an error is caused directly if there is a magnetic substance nearby.

Under the circumstances, there is proposed an educational simulator for ultrasonic diagnosis which does not rely on the magnetic spatial sensor. The technology of such a simulator is disclosed in Patent Publication No. 2002-336247. The object of that technology is to provide an image display device allowing operation training with a feeling similar to actual ultrasonic diagnosis, and the image display device comprises a dummy probe having a shape copying an ultrasonic probe, used for indicating a display range of an image; a pseudo body surface having a shape copying a human body surface brought into contact with the dummy probe, detecting a contact position of the dummy probe; an image memory storing three-dimensional image data inside a human body; a display range calculation part calculating a range of a tomographic image of the human body to be displayed; a signal processing part and an echo signal generation part deriving an image signal corresponding to the range calculated by the display range calculation part; and a display part displaying an image on the basis of the derived image signal, to solve the said problem. An inclination detecting means which detects the inclination of the dummy probe to the pseudo body surface relies on a light emitting diode mounted in the dummy probe, and a stereo television camera which takes the light radiated from the light emitting diode.

However, the technology disclosed in Patent Publication No. 2002-336247 targets organs in the digestive system such as the liver, kidney and spleen which can be ultrasonically examined from the abdomen, and the images shown are static. It is not suitable for examining a beating organ such as the heart. The technology does not require accuracy of detecting the position of the dummy probe as high as the simulator targeting the heart, and it cannot be applied to the educational simulator for echocardiography, as it is. Further, the technology uses a light emitting diode and a stereo television camera as the position sensor, and there are problems that the stereo television camera is the one which is not provided in the actual ultrasonic diagnostic apparatus, and that the equipment is relatively large.

### SUMMARY OF THE INVENTION

An object of the present invention, therefore, is to provide an educational echocardiographic apparatus excellent in portability which is an ultrasonic diagnostic simulator targeting the heart and which displays captured images similar to actual ultrasonic diagnosis, can run simulations in a feeling of scanning similar to actual ultrasonic diagnosis and grasps the position and inclination of the dummy probe relatively accurately and precisely.

To attain the said object, the educational simulator for transthoracic echocardiography according to a first embodiment of this patent application comprises a chest phantom having a chest in a chassis, with position sensors embedded at prescribed positions beneath the chest surface; a dummy probe patterned after an ultrasonic probe, in which a first magnet is embedded, which is provided with an inclination sensor placed in the acral part and which presses the prescribed position on the said chest surface; a memory section which stores time-series three-dimensional image data of echocardiography; a central processing unit (CPU) which calculates the position, direction, inclination and scope of the tomographic view of the three-dimensional image data from the information on the position of the said dummy probe on the said chest phantom and the rotation angle of the said dummy probe detected by the said position sensors and the information on the inclination of the said dummy probe detected by the said inclination sensor and clips two-dimensional image data from the said three-dimensional image data; and a display section which shows the said clipped two-dimensional image data, and in which the said position sensors are composed of a touch sensor which detects the position of the said dummy probe on a plane and a rotary encoder with a second magnet on its acral part which is positioned immediately beneath the said touch sensor and detects the rotation angle of the said dummy probe.

For reference, the time-series three-dimensional image data denote four-dimensional image data obtained by adding a time axis to three-dimensional image data.

Further, the educational simulator for transthoracic echocardiography according to a second embodiment of this patent application is the educational simulator for transthoracic echocardiography in the first embodiment, wherein the said time-series three-dimensional image data of echocardiography are echocardiographic three-dimensional real image data and/or echocardiographic three-dimensional virtual image data, and the said two-dimensional images shown on the said display section are two-dimensional images on the basis of the said three-dimensional real image data and/or the said three-dimensional virtual image data, or three-dimensional image data in which the said three-dimensional real image data and the said three-dimensional virtual image data are superimposed, and the said display section shows the heart as if it pulsates continuously, by repeatedly showing the time-series data on one or several beats of the heart.

For reference, the virtual images in the three-dimensional virtual image data denote outline images, tomographic images and so on made out on the basis of real images.

Also, the educational simulator for transthoracic echocardiography according to a third embodiment of this patent application is the educational simulator for transthoracic echocardiography in the first embodiment, wherein the said chest is composed of a chassis made of hard synthetic resin and a close-fitting surface sheet made of soft synthetic resin covering the chassis, and wherein the said touch sensor is put between the said chassis of synthetic resin and the said surface sheet of synthetic resin and the said rotary encoder provided with the second magnet on the acral part is placed within the said chassis of synthetic resin immediately beneath the said touch sensor, with the second magnet facing the said chest surface.

Further, the educational simulator for transthoracic echocardiography according to a fourth embodiment of this patent application is the educational simulator for transthoracic echocardiography in the first embodiment, wherein the said inclination sensor comprises force resistor sensors and at least three force resistor sensors are collaterally placed along the outer edge on the tip of the said dummy probe.

Also, the educational simulator for transthoracic echocardiography according to a fifth embodiment of this patent application is the educational simulator for transthoracic echocardiography in the first embodiment, wherein the said inclination sensor comprises accelerometers which are placed on the acral part of the said dummy probe and in the said chest phantom.

Further, the educational simulator for transthoracic echocardiography according to a sixth embodiment of this patent application is the educational simulator for transthoracic echocardiography in the first embodiment, wherein the said CPU changes the brightness of the said two-dimensional images partially or wholly or add noise to the said two-dimensional images according to the information on the pressing force of the said dummy probe detected by the said inclination sensor.

Also, the educational simulator for transthoracic echocardiography according to a seventh embodiment of this patent application is the educational simulator for transthoracic echocardiography in the first embodiment, wherein the display section shows the said two-dimensional image data only when the said dummy probe presses the prescribed position to be examined.

Further, the educational simulator for transthoracic echocardiography according to an eighth embodiment of this patent application is the educational simulator for transthoracic echocardiography in the first embodiment, wherein a communicating means is provided which tells that the prescribed position to be examined is pressed when the said dummy probe presses the prescribed position to be examined, the said communicating means being any one or more of a prescribed image shown on the said display section, prescribed voice from the said display section and/or vibration by a vibrating motor embedded in the said dummy probe.

### BRIEF DESCRIPTION OF THE DRAWINGS

FIG. 1 is a pattern diagram of the external appearance of the educational simulator for transthoracic echocardiography relating to the embodiment.

FIG. 2 is an enlarged sectional view of part 11 of the embodiment in FIG. 1.

FIG. 3 is a block diagram of the components of the educational simulator for transthoracic echocardiography relating to the embodiment.

FIG. 4 is drawings imaging diagnosis by the educational simulator for transthoracic echocardiography relating to the embodiment.

FIG. 5 is an image display flowchart of the educational simulator for transthoracic echocardiography relating to the embodiment.

### DETAILED DESCRIPTION OF THE PREFERRED EMBODIMENTS

The present invention brings about the following effects with the said composition:

(1) The sensors used are position sensors embedded at prescribed positions in the chest phantom and an inclination sensor mounted on the tip of the dummy probe. Since these sensors are relatively small and inexpensive, the educational simulator for transthoracic echocardiography itself can be compact, is inexpensive and is excellent in portability.

(2) The dummy probe is of simple structure having an embedded magnet and is equipped with the inclination sensor comprising force resistor sensors or accelerometers on the acral part so that the dummy probe can be of a shape and weight like the actual ultrasonic probe.

(3) Since the position sensor comprises a touch sensor and a rotary encoder with a magnet on the acral part, the touch sensor, magnet and rotary encoder can be downsized. They can be embedded at prescribed positions although the prescribed positions in the chest phantom are near. As the rotary encoder woks normally even in an inclined state, it is not necessary to keep the chest phantom in a supine state, and the chest phantom can be used in a lateral or seated state, too like when actual diagnosis is performed.

(4) It is possible to learn not only the optimum point of dummy probe scanning but also diagnostic technology of pathologic condition from images obtained, since the memory section stores serial three-dimensional data as time-series moving images and the display section shows two-dimensional moving images clipped to dummy probe scanning. According to claim 3 of this patent application the display section can show the heart as if it pulsates continuously, by repeatedly showing the time-series data on one or several beats of the heart, clipped from time-series three-dimensional data.

(5) The present invention facilitates the readout of given information and the acquisition of the readout technology of two-dimensional images in ultrasonic diagnosis, because of two-dimensional virtual image data provided, although it is not easy for even an expert to read given information from two-dimensional images shown on the display section in actual echocardiographic diagnosis.

(6) In the actual echocardiographic apparatus, the ultrasonic probe is strongly pressed to a position on the chest surface whereby touch to the surface of skin is enhanced so that the position is shown vividly. The present invented simulator changes the brightness of two-dimensional images partially or wholly, or add noise to the two-dimensional images so as to make them unclear, according to the information on the degree of the pressing force of the dummy probe detected by the inclination sensor so that the operator can have simulated experience.

(7) When the dummy probe is put at the correct position to be examined on the chest phantom, the display section shows two-dimensional image data, or the communicating means provided tells that the dummy probe presses the correct position to be examined. It is therefore possible to confirm the correct position to be examined visually, aurally or tactually.

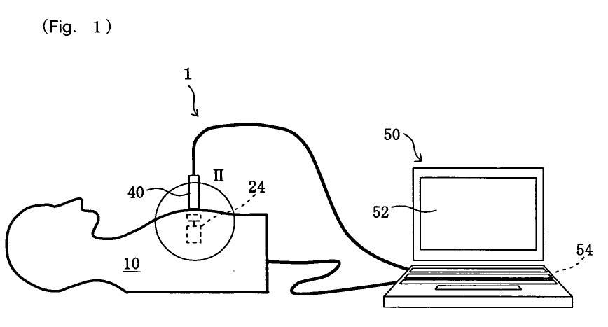

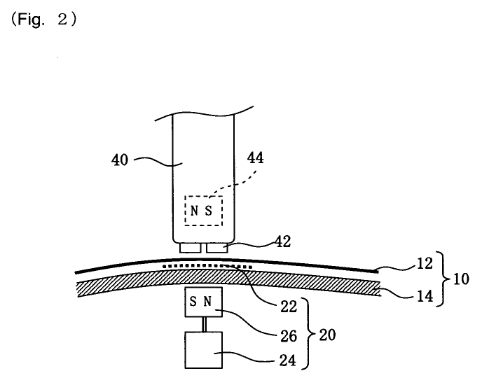

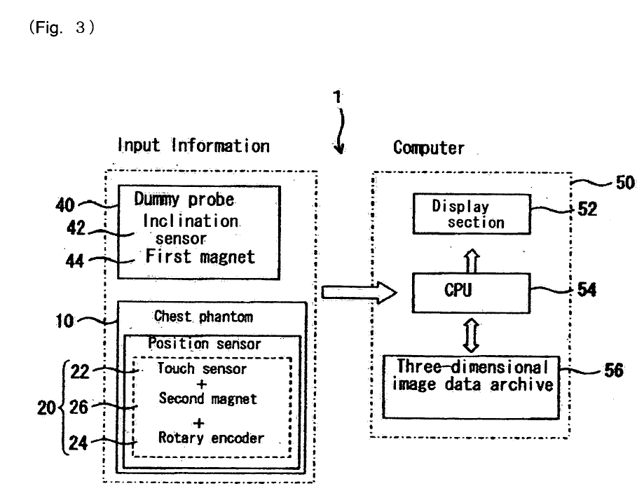

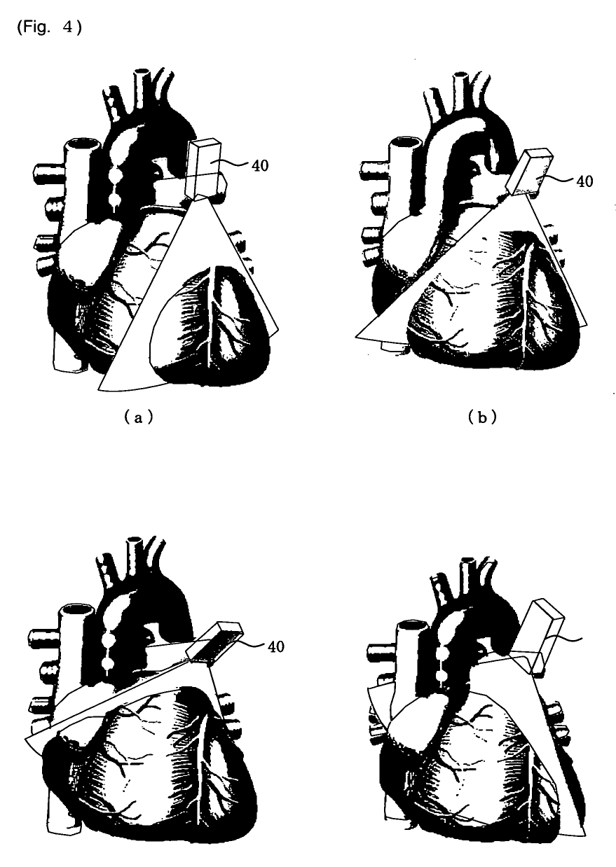

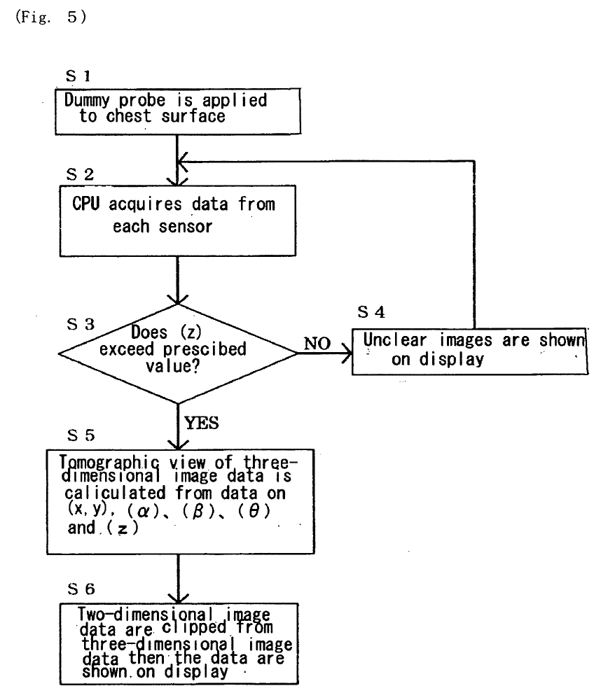

A description is hereinafter made of an embodiment of the present invention in the best feature to carry out the present invention, on the basis of FIG. 1-4. FIG. 1 is a pattern diagram of the external appearance of the educational simulator for transthoracic echocardiography relating to the embodiment. FIG. 2 is an enlarged sectional view of part 11 of the embodiment in FIG. 1. FIG. 3 is a block diagram of the components of the educational simulator for transthoracic echocardiography relating to the embodiment. FIG. 4 is drawings imaging diagnosis by the educational simulator for transthoracic echocardiography relating to the embodiment. FIG. 5 is an image display flowchart of the educational simulator for transthoracic echocardiography relating to the embodiment.

A description is hereinafter made of the composition and function of the educational simulator for transthoracic echocardiography 1 relating to the embodiment, on the basis of FIG. 1-4. Regarding the positional relation of the dummy probe an explanation is made, with the axis transversely running through the heart in the chest phantom defined as X-axis, with the axis longitudinally running through the heart and orthogonal to the X-axis defined as Y-axis, and with the axis orthogonal to the X-axis and the Y-axis defined as Z-axis.

The educational simulator for transthoracic echocardiography 1 comprises the chest phantom 10, dummy probe 40 and personal computer 50.

The chest phantom 10 is composed of the chassis 14 patterned after the shape of the chest, and the surface sheet 12 covering the surface of the chassis 14. The chassis 14 is made of elastic hard synthetic resin. The chassis 14 is split into a front part and a rear part, and the front part is designed to fit into the rear part and to be freely detachable. The surface sheet 12 is made of elastic soft synthetic resin having a touch like the skin, and is designed to be close-fitting to the chassis 14.

The touch sensor 22 which is sheet-like is placed on the surface of the chassis 14 and covered with the surface sheet 12. As mentioned above, the touch sensor 22 is placed at the prescribed position where echocardiographic records can actually be acquired, and when the dummy probe 40 described later presses the touch sensor 22 via the surface sheet 12, the touch sensor 22 detects a coordinate (x, y) which is the position on the plane of the dummy probe 40.

The rotary encoder 24 and second magnet 26 are placed in the chassis 14 immediately beneath the touch sensor 22. The rotary encoder 24 and second magnet 26 are linked to each other. The second magnet 26 rotates in response to the rotation of the first magnet 44 embedded in the dummy probe 40, and owing to the rotation of the second magnet 26 the rotary encoder 24 detects the rotation angle (θ) of the dummy probe 40 by outputting pulses in response to the rotation angle of the rotary encoder 24. The rotary encoder 24 works normally even in an inclined state so that it is not necessary to place the chest phantom 10 in a supine state, and the chest phantom 10 can be used even in any actual diagnosing state such as a lateral or seated state.

The dummy probe 40, patterned after the actual ultrasonic probe, is provided with the inclination sensor 42 comprising four force resistor sensors on the acral part, and incorporates the first magnet 44. The acral part of the dummy probe 40 is nearly square with a flat surface. The four force resistor sensors of which the inclination sensor 42 is composed are collaterally placed along the outer edge of the nearly square flat surface, namely at four corners of the nearly square flat surface. When the dummy probe 40 is pressed to the chest phantom 10, the four force resistor sensors each detect pressing force independently. The total of the pressing force of the four force resistor sensors is the pressing force (z) of the dummy probe 40.

Suppose that two diagonal lines intersecting at right angles are drawn on the nearly square flat surface of the acral part of the dummy probe 40 and they are named X′-axis and Y′-axis respectively. Two force resistor sensors are placed on the X′-axis and also two force resistor sensors are placed on the Y′-axis. The difference in the pressing force between the two force resistor sensors on the X′-axis is the inclination of the dummy probe 40 to the X′-axis (pitch [α]) and likewise the difference in the pressing force between the two force resistor sensors on the Y′-axis is the inclination of the dummy probe 40 to the Y′-axis (roll[β]).

As mentioned above, owing to the rotation of the first magnet 44 the rotary encoder 24 works and detects the rotation angle (θ) of the dummy probe 40. This rotation angle (θ) compensates the pitch [α] to the X′-axis and the roll angle[β] to the Y′-axis, and the inclination of the dummy probe 40 to the X-axis and Y-axis is calculated by the CPU 54 described later. The first magnet 44 and second magnet 26 may be electromagnets, while the embodiment uses permanent magnets. The equipment is made compact by using permanent magnets.

Then, on the basis of FIG. 4 a description is hereinafter made of information on the position of the dummy probe 40 on the chest phantom 10 which is detected by the position sensors 20 and the rotation angle of the dummy probe 40 and information on the inclination of the dummy probe 40 which is detected by the inclination sensor 42 and the relation of the position, direction, inclination and scope of the tomographic view with the three-dimensional image data.

FIG. 4 (a)-(d) indicate the method of acquiring representative diagnostic tomographic views in a state of making a coordinate (x, y) as the position of the dummy probe 40 on a plane the same. Namely, FIG. 4 (a)-(c) indicate the state of gradually increasing the inclination of the dummy probe 40 to the Y-axis while the direction of the dummy probe 40 is kept nearly parallel with the X-axis. FIG. 4 (d) indicates the state of rotating the dummy probe 40 nearly 90° from the direction nearly parallel with the X-axis. In FIG. 4 (a)-(d), the range of reach of ultrasonic waves is shown as the sector surrounded and formed by two radii extending downward from the tip of the dummy probe 40 and a circular arc between the radii.

This sector is a tomographic view of three-dimensional image data. The coordinate (x, y) as the position of the dummy probe 40 on the plane denotes the ‘position’ of the tomographic view. The direction of the dummy probe 40 in FIG. 4 (a)-(d) denotes the ‘direction’ of the tomographic view. The inclination of the dummy probe 40 to the X-axis and Y-axis in FIG. 4 (a)-(d) denotes the ‘inclination’ of the tomographic view. The sector itself extending downward from the tip of the dummy probe 40 denotes the ‘scope’ of the tomographic view.

Accelerometers can be used as the inclination sensor 42, instead of the four force resistor sensors. In this case, one triaxial accelerometer each is placed in the chest phantom 10 and in the dummy probe 40. These accelerometers are elements outputting the inclination of each of the X, Y, Z, X′, Y′ and Z′ axes to the gravitational line. These elements enable the relative inclination of the dummy probe 40 to the chest phantom 10 to be acquired in the three-dimensional direction. Further, a pressure relating to the scanning of the dummy probe 40 can be detected by the accelerometer in the dummy probe 40.

The rotational direction of the dummy probe 40 is detected by the first magnet 44, the second magnet 26 in response to the first magnet 44, and the rotary encoder 24, as already mentioned.

The personal computer 50 comprises the display section 52, CPU 54 and three-dimensional image data archive 56.

The three-dimensional image data archive 56 stores three-dimensional echocardiographic real images of healthy subjects, three-dimensional echocardiographic real images of subjects having cardiac diseases, and echocardiographic virtual images which are outline images or tomographic images made out on the basis of the said three-dimensional echocardiographic real images. The CPU 54 calculates the position, direction, inclination and scope of tomographic views of three-dimensional images indicated by the dummy probe 40, on the basis of the data on the coordinate (x, y) of the dummy probe 40 by the touch sensor 22, the data on the rotation angle (θ) of the dummy probe 40 by the rotary encoder 24 and the data on the pitch angle (α) and roll angle (β) of the dummy probe 40 by the inclination sensor 42, and clips two-dimensional image data from the three-dimensional image data such as three-dimensional echocardiographic real images and three-dimensional echocardiographic virtual images stored in the three-dimensional image data archive 56. The display section 52 shows the clipped two-dimensional data.

In showing the two-dimensional image data on the display section 52, the invented simulator changes the brightness of the shown two-dimensional images partially or wholly, or adds noise to the two-dimensional images so as to make them unclear, on the basis of information on the pressing force (z) of the dummy probe 40, namely according to the information on the degree of the pressing force (z) of the dummy probe 40.

The degree of the pressing force of an ultrasonic probe to a body surface is an important factor in an actual echocardiographic apparatus. Namely, ultrasonic waves reach a deep position in the heart by strongly pressing the ultrasonic probe to the body surface so that images focusing that position are shown, and the images are designed to be distorted unless the ultrasonic probe is pressed with the prescribed force. The present invention enables an operator to have simulated experience like manipulating the actual ultrasonic probe, by changing the brightness of the images shown on the display section 52 or making the images unclear by adding noise.

There may be provided a communicating means which tells that a correct position to be examined is pressed, when the dummy probe 40 presses the prescribed correct position to be examined. Such a communicating means makes the display section 52 indicate that the correct position to be examined is pressed, or makes the display section 52 emit a vocal message that the correct position to be examined is pressed, or makes the dummy probe 40 itself vibrate by means of a vibration motor embedded in the dummy probe 40.

The echocardiographic real images stored in the said three-dimensional image data archive 56 are three-dimensional real moving images recorded for one or several beats of the heart so as to indicate the pulsation. Actually, the images are three-dimensional real images carrying a time axis. The echocardiographic images shown on the display section 52 are two-dimensional images which are time-series two-dimensional moving images carrying a time axis.

A description is hereinafter made in sequence of a mode of using the educational simulator for transthoracic echocardiography 1 relating to the embodiment, on the basis of FIG. 5.

(1) The educational simulator for transthoracic echocardiography 1 is switched on, and the dummy probe 40 is applied and pressed to the prescribed position on the surface sheet 12. (Step S1) Since the touch sensor 22 is placed at the prescribed position beneath the surface sheet 12, the touch sensor 22 does not sense the dummy probe 40 in other positions.

(2) The CPU 54 acquires information transmitted from each sensor, namely the touch sensor 22, rotary encoder 24 and inclination sensor 42. (Step S2)

(3) The CPU 54 judges whether the pressing force (z) of the dummy probe 40 transmitted from the inclination sensor 42 exceeds the prescribed value. If the pressing force (z) is the prescribed value or less, the operator advances to Step 4. If the pressing force (z) exceeds the prescribed value, the operator advances to Step 5. (Step 3)

(4) In Step 4 the display section 52 shows unclear images with noise. As mentioned above, in the actual echocardiographic apparatus ultrasonic waves reflect diffusely on the way and the images are distorted, unless the ultrasonic probe is pressed to the body surface with the prescribed force. In the invented simulator, too unclear images are shown unless the dummy probe 40 is pressed to the surface sheet 12 with the prescribed force, and so the operator can obtain nearly the same feeling as in the actual echocardiographic apparatus. If the pressing force (z) of the dummy probe 40 exceeds the prescribed value, the operator advances to Step 5 via Step 3.

Only when the dummy probe 40 presses the prescribed position to be examined, the operator may make the display section 52 show two-dimensional images, or may make the display section 52 show that the dummy probe 40 presses the prescribed diagnostic position or make the display section 52 emit a vocal message that the dummy probe 40 presses the prescribed position to be examined or make the dummy probe 40 vibrate by a vibration motor (unillustrated) embedded in the dummy probe 40.

When the pressing force (z) of the dummy probe 40 exceeds the prescribed value, the CPU 54 calculates the position, direction, inclination and scope of the tomographic view of the three-dimensional images indicated by the dummy probe 40, on the basis of the data on the coordinate (x, y) of the dummy probe 40 by the touch sensor 22, the data on the rotation angle (θ) of the dummy probe 40 by the rotary encoder 24 and the data on the pitch (α) and roll (β) of the dummy probe 40 by the inclination sensor 42, and clips two-dimensional image data from the three-dimensional image data stored in the three-dimensional image data archive 56. (Step S5)

Namely, the position and direction of the tomographic view of the three-dimensional image data are specified from the coordinate (x, y) and the rotation angle (θ), and the inclination and scope of the tomographic view are specified from the pitch (α) and roll (β), and the two-dimensional image data are clipped. Further, the brightness of part of the clipped two-dimensional image data is changed according to the pressing force (z)

The two-dimensional image data clipped in Step 5 are shown on the display section 52 as two-dimensional images. (Step S6)

The above description is an example of using the educational simulator for transthoracic echocardiography 1 relating to the embodiment.

What is claimed is:

1. A graphic input device for measuring a displacement of a pen-shaped pointing device relative to a writing surface in two directions in space, wherein displacement measuring means in each direction comprise:
A. means in the pointing device for transmitting ultrasonic (US) continuous waves (CW) propagating in the air in generally that direction, such as part of the US waves illuminate the surface;
B. means on the writing surface for reflecting part of the US waves back, generally towards the pen-shaped pointing device;
C. means in the pen-shaped pointing device for receiving US waves reflected off the surface from that general direction;
D. means for measuring a phase of the received waves, wherein a change in the phase is proportional to the pen-shaped pointing device's displacement relative to the writing surface in that direction;
E. means for electronic separation of US waves corresponding to one direction in space from US waves corresponding to the other direction in space.

2. The graphic input device according to claim 1, wherein the pointing device has a transmit and/or receive pattern that is implemented as a focused beam on the reflecting surface, in the near field of the transmit and/or receive transducer.

3. The graphic input device according to claim 1, wherein, in each direction, a single US transducer is used both for the transmitter and the receiver in that direction.

4. The graphic input device according to claim 3, wherein each US transducer has a transmit/receive pattern that is implemented as a focused beam on the reflecting surface, in the near field of the transducer.

5. The graphic input device according to claim 1, wherein the means for electronic separation of US waves in the two directions from each other comprise means for sending US waves at a different frequency in each direction.

6. The graphic input device according to claim 1, wherein the pen-shaped pointing device further includes an orientation indicator, to bring the pen-shaped pointing device into the correct orientation, wherein one ultrasonic beam generally points in the y-axis direction, and another ultrasonic beam points in the x-axis direction.

7. The graphic input device according to claim 1, further including one or more zero force buttons installed on the pen-shaped device.

8. The graphic input device according to claim 11, wherein the writing surface is a planar surface with corrugations for reflecting waves back, generally towards the pen-shaped pointing device.

9. A graphic input device for measuring a displacement of a pen-shaped pointing device relative to a writing surface in two directions in space, wherein displacement measuring means in each direction comprise:
A. means in the pointing device for transmitting ultrasonic (US) continuous waves (CW) propagating in the air in generally that direction;
B. a generally vertical surface, positioned at a fixed location and which is generally normal to the direction of propagation of waves in that direction, for reflecting the waves back toward the pen-shaped pointing device;
C. means in the pen-shaped pointing device for receiving US waves reflected off the surface from that general direction;
D. means for measuring a phase of the received waves, wherein a change in the phase is proportional to the pen-shaped pointing device's displacement relative to the writing surface in that direction;
E. means for electronic separation of US waves corresponding to one direction in space from US waves corresponding to the other direction in space.

10. The graphic input device according to claim 9, wherein the two vertical surfaces comprise one part with two surfaces connected at a normal angle therebetween.

11. The graphic input device according to claim 9, wherein each of the two vertical surfaces further include US waves dispersing means.

12. The graphic input device according to claim 9, wherein the means for electronic separation of US waves in the two directions from each other comprise means for sending US waves at a different frequency in each direction.

13. The graphic input device according to claim 9, wherein, in each direction, a single US transducer is used both for the transmitter and the receiver in that direction.

14. The graphic input device according to claim 9, wherein the pen-shaped pointing device further includes an orientation indicator, to bring the pen-shaped pointing device into the correct orientation, wherein one ultrasonic beam generally points in the y-axis direction, and another ultrasonic beam points in the x-axis direction.

15. The graphic input device according to claim 9, further including one or more zero force buttons installed on the pen-shaped device.

16. The graphic input device according to claim 9, wherein the writing surface is a smooth planar surface.

17. A graphic input device for measuring a displacement of a pen-shaped pointing device relative to a writing surface in two directions in space, wherein the two directions in space are about parallel to the writing surface and normal to each other, and the displacement measuring means in each direction comprise:
A. means in the pointing device for transmitting ultrasonic (US) continuous waves (CW) propagating in the air in generally that direction;
B. reflecting means positioned at a fixed location, for reflecting the waves back toward the pen-shaped pointing device;
C. means in the pen-shaped pointing device for receiving US waves reflected off the surface from that general direction;
D. means for measuring a phase of the received waves, wherein a change in the phase is indicative of the pen-shaped pointing device's displacement relative to the writing surface in that direction;
E. means for electronic separation of US waves corresponding to one direction in space from US waves corresponding to the other direction in space.

18. The graphic input device according to claim 17, wherein the means for electronic separation of US waves in the two directions from each other comprise means for sending US waves at a different frequency in each direction.

19. The graphic input device according to claim 17, further including means for measuring a the pen-shaped pointing device's displacement normal to the writing surface by measuring a phase of US waves reflected off that surface.

20. The graphic input device according to claim 17, further including one or more zero force buttons installed on the pointing device.
